(19) United States
(12) Patent Application Publication
(10) Pub. No.: US 2007/0245648 A1
(43) Pub. Date: Oct. 25, 2007

(54) Profiled Frame as a Component of a Window or Door

(76) Inventor: Rainer Hoffmann, Langenfeld (DE)

Correspondence Address: ROBERT W. BECKER & ASSOCIATES, 707 HIGHWAY 333, SUITE B, TIJERAS, NM, 87059-7507, US

(21) Appl. No.: 11/737,888

(22) Filed: Apr. 20, 2007

(30) Foreign Application Priority Data
Apr. 6, 2006 (DE) 10 2006 006 505.9

(51) Int. Cl. E06B 3/00

(52) U.S. Cl. 52/204.5

(57) ABSTRACT

A profiled frame, as a component of a window or door, for holding a plate-like panel supported in a circumferential frame, and comprising a profiled frame member having a profiled chamber that extends over at least a portion of the longitudinal length of the profiled frame member; molded elements to be inserted into, and positively held by, the profiled chamber; a hinge shaft for insertion through bores of the molded elements; and at least one monolithic hinge to be disposed between molded elements for mounting the profiled frame on a supporting component, wherein the hinge has a hinge bore via which the hinge can be threaded onto the hinge shaft, and wherein the hinge is fixed in position on the hinge shaft via adjoining molded elements.

The instant application should be granted the priority date of Apr. 20, 2006 the filing date of the corresponding German patent application 10 2006 006 505.9.

### BACKGROUND OF THE INVENTION

The present invention relates to a profiled frame, as a component of a window or door, for holding a plate-like panel supported in a circumferential frame, whereby at least one hinge is mounted on the profiled frame member of the profiled frame for mounting the window or door on a supporting component. The panel disposed on the profiled frame can be made of glass or also of some other suitable and if desired non-transparent material.

Known windows or doors of circumferential profiled frames having variously configured profiled frame members have the drawback that for the mounting of hinges or hinge components on the profiled frame, the profiled frame member must at a later point in time be notched or recessed at the pertaining location that is provided for the hinge of the window or door in order to be able to secure to the profiled frame one part of a generally two-part hinge, whereby the hinge part that is thus secured to the window or the door is installed together with an associated counter member of the hinge via a hinge shaft, or must be mounted together upon final installation of the window or door.

It is therefore an object of the present invention to improve a profiled frame of the aforementioned general type and to embody it in such a way that the mounting of hinges on the profiled frame is simplified.

### BRIEF DESCRIPTION OF THE DRAWING

This object, and other objects and advantages of the present invention, will appear more clearly from the following specification in conjunction with the accompanying schematic drawing, in which:

FIG. 1 shows a portion of a profiled frame member that forms a profiled frame and has hinges mounted thereon; and

FIG. 2 is a cross-sectional view through the subject matter of FIG. 1;

### SUMMARY OF THE INVENTION

The basic concept of the present application is that the profiled frame member has an additional profiled chamber that extends over at least a portion of the longitudinal length of the profiled frame member and that serves for a positive or interlocking support of molded elements that can be inserted into the profiled chamber, whereby the molded elements have a bore for receiving a hinge shaft that can be inserted through the molded elements, and wherein between two respective molded elements a monolithically formed hinge can be threaded via its hinge bore onto the hinge shaft and can be fixed in position by the adjoining molded elements,

The inventive profiled frame has the advantage that a machining of the profiled frame member for the mounting of hinges or hinge parts is entirely avoided since the hinge shaft is supported by the molded elements, which are positively held in the profiled frame member, and the hinges, which are monolithically formed, are adapted to be shoved or inserted onto the hinge shaft by means of the hinge bore. Thus, not only are the hinges themselves configured in a more straightforward manner as monolithic components, and therefore can be produced more economically, but rather also mounting of the hinges on the profiled frame is simplified, since the individual components, such as the molded elements, the hinge shaft and the hinges, merely need to be inserted into one another. In this connection, the arrangement or position of the hinges can advantageously be variably determined, because the molded elements that are disposed between the hinges function as spacers for the hinges and can thus be cut to an appropriate length from an initially continuous profiled element in conformity with the desired arrangement of the hinges on the profiled frame.

Pursuant to one embodiment of the invention, the monolithic hinge comprises a hinge leaf having the hinge bore at one of its ends and a mounting leg on the other end of the hinge leaf for mounting of the hinge on a component that carries the door or the window. Such hinges are easy to produce.

To ensure a hinge movement that is free of friction, the bore that is formed in the molded elements for receiving the hinge shaft can be disposed beyond the profiled frame member.

Pursuant to an embodiment of the invention, with regard to the configuration of the molded elements, the molded elements can have a two-leg configuration including a profiled leg that via its profiled element can be inserted into the profiled chamber of the profiled frame member, with the bore for receiving the hinged shaft being formed in the connection region of the two legs. The freely projecting leg of the molded elements can have its orientation adapted or conformed to the position of the hinge leaf of the hinges when the door or window is closed. Thus, when the door or window is closed, an optically closed overall impression of the circumferential profiled frame results without the hinges or their support means being visible.

If the molded elements that are inserted into the additional chamber of the profiled frame member are to absorb the hinge forces via the hinge shaft that extends through the molded elements, it is proposed pursuant to another embodiment of the invention that the profiled frame member be provided with support strips that extend beyond the additional profiled member for receiving the molded elements, with the support strips resting against the molded elements. The outer surface of the support strips that are formed on the profiled frame member can be provided with support surfaces that are adapted or conformed to the outer contour of the molded elements.

Finally, the molded elements, which are disposed on the outer ends of the profiled frame member, which borders the panel and forms the circumferential profiled frame, can be fixed to the profiled frame member.

Further specific features of the present application will be described in detail subsequently.

### DESCRIPTION OF SPECIFIC EMBODIMENTS

Referring now to the drawing in detail, as can be seen best in FIG. 2, the profiled frame member 10, which is used to form a profiled frame that forms a door or a window, is provided with a first profiled chamber 11 in which the panel, preferably a glass pane, can be placed and fixed in position. The profiled frame member 10 furthermore has an additional profiled chamber 12 into which can be inserted a molded element 13 that can accordingly be positively or interlockingly fixed in position on the profiled frame member 10. For this purpose, the molded element 13 has a profiled leg 14, the profiled shape of which corresponds to the shape of the additional profiled chamber 12 such that when the profiled leg 14 is inserted into the profiled chamber 12, it is fixed in position on the profiled frame member 10 without the need for further securement measures.

The molded element 13, which is fixed in position on the profiled frame member 10, has two legs, and in particular in addition to the profiled leg 14 has a freely projecting leg 15, which in the illustrated embodiment is disposed at right angles to the profiled leg 14. Formed in the transition region between the profiled leg 14 and the freely projecting leg 15 is a bore 16, into which can be inserted a hinge shaft 17 for the mounting of the window or door.

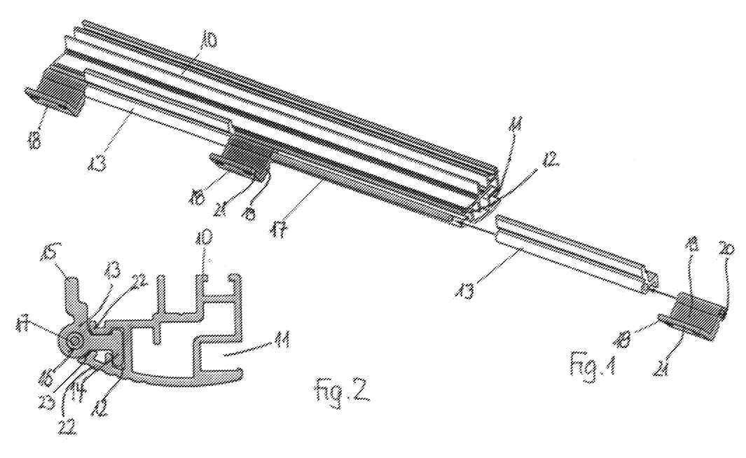

The cooperation of the individual components can be seen from FIG. 1. As illustrated, with a continuous profiled frame member 10 as in the illustrated embodiment, three hinges 18 can or should be installed together. The hinges 18 that are to be mounted on the profiled frame member 10 have a monolithic construction, and are provided with a hinge leaf 19, on the free end of which is formed the hinge bore 20 of the hinge 18. In the final installed state, the hinge bore 20 extends around the hinge shaft 17, so that the hinge 18 is rotatable about the corresponding hinge shaft 17. Disposed on the other end of the hinge leaf 19 is a mounting leg 21 by means of which a hinge 18 can be secured to a component that supports the door or window that is formed by the profiled frame member 10.

As can be seen from FIGS, 1 and 2, two molded elements 13, via their profiled legs 14, are inserted into the longitudinally extending profiled frame member 10, and in particular into the additional profiled chamber 12 thereof. The hinge shaft 17 is inserted into the bores 16 of the two molded elements 13, wherein the bores 16 are disposed beyond the profiled frame member 10. To mount the hinges 18 on the profiled frame member 10, the hinges 18 are threaded onto the hinge shaft 17, whereby the molded elements 13 that are disposed between the respective hinges 18 act as spacers between the hinges and thus fix the hinges in their positions. It is judicious for the two hinges 18 that are disposed at the ends of the profiled frame member component illustrated in FIG. 1 to require a further fixing, and in particular either by means of additional molded elements 13 that are placed against them from the outside, or by means of a corner connector or further profiled frame members 10 that are disposed transversely for the formation of a profiled frame as is customary with doors or windows.

It is conceivable that the free leg 15 of the molded element 13 be oriented and profiled in such a way that in the closed position of the not otherwise illustrated window, or a pertaining door, it is aligned with the hinged leaves 19 of the hinges 18, so that to this extent the molded elements 13 and the hinges 18 form an optical unit,

Since the load received by the hinges 18 is to be dissipated via the hinge shaft 17 into the molded elements 13, and from there into the profiled frame member 10, for a better support the profiled frame member 10 is provided with support strips 22 that project beyond the additional profiled chamber 12 and rest against the molded elements 13. The outer sides of the support strips 22 are provided with support surfaces 23 that conform to the outer contour of the molded elements 13 that rest against them. A transfer of force over the surface is thereby effected in these regions.

To install the hinges 18 on the profiled frame member 10, it is advantageously merely necessary to insert, in the desired arrangement, appropriately cut-to-size molded elements 13 having the hinge shaft 17 and the hinges 18 threaded thereon, into the additional profiled chamber 12 of the profiled frame member 10.

The features of the subject matter of this document disclosed in the preceding description, the claims and the drawing can be important individually or in any desired combination with one another for realizing the various embodiments of the invention,

The specification incorporates by reference the disclosure of German priority document 10 2006 006 505.9 filed Apr. 20 2006.

The present invention is, of course, in no way restricted to the specific disclosure of the specification and drawing, but also encompasses any modifications within the scope of the appended claims.

What I claim is:

1. A profiled frame, adapted to be a component of a window or door, for holding a plate-like panel supported in a circumferential frame, comprising:
a profiled frame member (10) having a profiled chamber (12) that extends over at least a portion of a longitudinal length of said profiled frame member (10);
molded elements (13) adapted to be inserted into, and positively held by, said profiled chamber (12), wherein said molded elements (13) are each provided with a bore (16);
a hinge shaft (17) adapted to be inserted through said bores (16) of said molded elements (13); and
at least one monolithic hinge (18) adapted to be disposed between ones of said molded elements (13) for mounting the profiled frame on a supporting component, wherein said monolithic hinge (18) has a hinge bore (20) via which said hinge is adapted to be threaded onto said hinge shaft (17), and wherein said at least one monolithic hinge (18) is fixed in position on said hinge shaft (17) via adjoining ones of said molded elements (13).

2. A profiled frame according to claim 1, wherein said at least one monolithic hinge (18) is comprised of a hinge leaf (19), wherein said hinge bore (20) is formed at one end of said hinge leaf (19), and is further comprised of a mounting leg (21) that is disposed at another end of said hinge leaf (19) for a mounting of said at least one hinge (18) on the component for supporting the door or window.

3. A profiled frame according to claim 1, wherein said bore (16) provided in each of said molded elements (13) for receiving said hinge shaft (17) is disposed beyond said profiled frame member (10).

4. A profiled frame according to claim 3, wherein each of said molded elements (13) is provided with two legs, including a profiled leg (14) that is insertable via a profiled element thereof into said profiled chamber (12) of said profiled frame member (10), and wherein said bore (16) of said molded element (13) for receiving said hinge shaft (17) is formed in a region that interconnects the two legs (14, 15) of said molded element (13).

5. A profiled frame according to claim 4, in which said second, freely projecting leg (15) of said molded element (13) has an orientation that is adapted to a position of said hinge leaf (19) of said at least one hinge (18) when the door or window is closed.

6. A profiled frame according to claim 1, wherein said profiled frame member (10) is provided with support strips (22) that extend beyond said profiled chamber (12) for receiving said molded elements (13), and wherein said support strips (22) rest against said molded elements (13).

7. A profiled frame according to claim 6, wherein said support strips (22) of said profiled frame member (10) are provided with outer surfaces (23) that are adapted to an outer contour of said molded elements (13).

8. A profiled frame according to claim 1, wherein said molded elements (13) are disposed on outer ends of said profiled frame member (10) and are fixed thereto, and wherein said profiled frame member (10) borders the panel and forms the circumferential profiled frame.
